(19) United States
(12) Patent Application Publication
(10) Pub. No.: US 2009/0102185 A1
(43) Pub. Date: Apr. 23, 2009

(54) Device for sealing untight couplings and press connections

(76) Inventor: Agim Ramnabaja, Zurich (CH)

Correspondence Address: Anthony Claiborne, 849 136th Ave. N.E., Bellevue, WA, 98005, US

(21) Appl. No.: 11/585,657

(22) Filed: Oct. 24, 2006

(30) Foreign Application Priority Data
Oct. 25, 2005 (CH) 01713/05
Oct. 26, 2005 (DE) 20 2005 016 869.6

(51) Int. Cl. F16L 55/00

(52) U.S. Cl. 285/55

(57) ABSTRACT

A device (1), for sealing untight couplings and press connections consists of a pressing piece (2) which encompasses the periphery of the pipe, with which an additional seal (6) is pressed onto the intermediate space between the coupling (4) and the pipe (5), and of a counter-piece (3) which encompasses the coupling body and by way of which the pressing piece (2) is pulled in the direction of the coupling body and fixed with a form- and force-fit. The pressing piece (2) has essentially the shape of a hollow cylinder with an outer thread with an inner diameter which is equally large as the outer diameter of the pipe (5), and an outer diameter which is larger than the maximal diameter of the coupling (4). The counter-piece (3) likewise has essentially the shape of a hollow cylinder. The inner diameter over a part of the length of the counter-piece (3) corresponds to the diameter of a coupling (4) between the outer beads. The counter-piece over the remaining length has an inner thread with the same diameter as the outer thread of the pressing piece (2). After a new seal (6) has been attached by way of wrapping a sealing cord around the pipe (5), the pressing piece (2) is screwed into the counter-piece (3), and thus presses the seal (6) onto the gap between the pipe (5) and the coupling (6).

### BACKGROUND OF THE INVENTION

1. Field of the Invention

The invention relates to a device for sealing untight couplings and untight press connections. More particularly, this invention relates to such a device with a pressing piece which may be attached around a pipe and with a counter-piece which may be attached around a coupling connected to the pipe, wherein the pressing piece and the counter-piece are connectable to one another with a form-fit and/or force-fit.

2. Description of the Related Art

On installation, pipes for the transport of gases and fluids as a rule are coupled by way of couplings. With traditional technology, sealing material e.g. hemp fibers, is wound around the pipes, and the pipes inserted into the coupling. The sealing material swells due to the absorption of moisture and seals the coupling connection. With a modern solution for pipes of plastic, the coupling and the pipe are heated and welded by way of a current conductor applied into this so-called welding coupling.

Today, the pipes as a rule are connected by press couplings for the efficient installation of pipe conduits. A metal pipe is inserted into a plastically deformable metal coupling with such press connections or press fittings. This coupling at the longitudinal ends comprises a hollow bead into which a sealing ring of an elastomer is applied. Such a press connection is shown for example in EP 1,505,329 A2.

Subsequently, the coupling is pressed with the pipe by way of a tool which is specially envisaged for this purpose. On the one hand, this leads to a form-fit and force-fit connection of the coupling and pipe, and on the other hand to a tight sealing of the connection by way of an elastic deformation of the sealing ring in the bead.

The sealing ring of the press coupling may become damaged by way of incorrect handling. The press connection is then not tight after the pressing. It is just as possible for a pipe to unnoticeably get damaged, for example on cutting to length by way of a saw, which likewise may lead to a leaky coupling connection. The plastic of the sealing rings may furthermore age, and thereby become brittle and fractured. In the near future therefore, one has to reckon with an increase in untight press connections.

Since a conduit system is usually filled only until after the final creation, any leakage is often not discovered and repaired only until after the completion of the assembly. Whereas solutions are known for the repair of leakages of pipes during operation, thus without the exchange of the defective pipe, defective coupling connections, in particular press connections must be completely exchanged. For this, the conduit system needs to be emptied, which may take time with larger systems, such as heating installations of larger buildings for example. With certain systems, for example air conditioning systems, the contents of the conduit may furthermore not be simply let out into the canalization, since it contains toxic substances, and for this reason must be collected. After the emptying, the defective coupling must be removed, which is only possible by sawing off. Then, even in the simpler cases, two press couplings and an intermediate pipe piece are required for the repair. With more complex cases, for example with T-pieces, the material and time expense is even greater. The conduit system must be filled again after the repair of the leakage, and thereby it must also be bled, which likewise may take some time. It is therefore indeed possible for the repair of one single untight press coupling to take several hours.

### BRIEF SUMMARY OF THE INVENTION

It is an object of the invention to provide a sealing device of the initially mentioned type, with which untight couplings and press connections may be rapidly and permanently sealed and repaired during the operation of the conduit system and without a complex exchange of the connection.

The principle of a sealing device according to the invention is based on the fact that an unsealed coupling connection at the entry location of the pipe into the coupling is newly sealed over the complete pipe periphery. For this purpose, the device according to the invention consists of a pressing piece which encompasses the pipe periphery and with which an additional seal is pressed onto the intermediate space between the coupling and pipe, and of a counter-piece encompassing the coupling body, by way of which the pressing piece may be pulled in the direction of the coupling body and fixed with a form fit and force fit.

The pressing piece of a sealing device according to the invention essentially has the shape of a hollow cylinder with an outer thread with an inner diameter which is equally large or slightly larger than the outer diameter of the pipe, and with an outer diameter which is larger than the maximal diameter of the coupling.

The counter-piece likewise has essentially the shape of a hollow cylinder. Over a part of the length of the counter-piece, the inner diameter corresponds to the diameter of a coupling between the outer beads. This region later encloses the coupling. Over the remaining length, the counter-piece has an inner thread with the same diameter as the outer thread of the pressing piece. After a new seal has been attached, by way of wrapping the pipe with sealing cord in the region of the coupling bead or by mounting a suitably modified sealing ring, the pressing piece is screwed into the counter-piece and thus presses the seal onto the gap between the pipe and the coupling.

In order for the pressing piece and the counter-piece of a sealing device according to the invention to be able to be assembled around the finished installed pipe or around the coupling, they must in each case consist of at least two semi-shells which have an opening angle of maximal 180 degrees. The at least two parts of the counter-piece must be connected to one another with a form-fit and/or force-ft. With regard to the pressing piece which is screwed into the counter-piece, the at least two parts do not necessarily need to be connected to one another since these are fixed onto one another alone by way of the screwing-in.

It is additionally advantageous to equip the pressing piece and counter-piece with means which permit a torque to be exerted onto these. Recesses for example are possible, onto which pliers may engage, or coupling locations for special keys or tools.

### BRIEF DESCRIPTION OF THE DRAWINGS

These and other objects, advantages, features and characteristics of the present invention, as well as methods, operation and function of related elements of structure, and the combination of parts and economies of deployment, will become apparent upon consideration of the following description and claims with reference to the accompanying drawings, all of which form a part of this specification, wherein:

FIG. 1 in a longitudinal section shows a press connection, consisting of a press coupling with an inserted pipe, with which liquid or gas escapes through a leak in the seal of the press coupling.

FIG. 2 in a longitudinal section, shows the untight press connection of FIG. 1, sealed by a sealing device according to the invention, essentially consisting of a pressing piece and a counter-piece.

FIG. 3a in a longitudinal section, shows the counter-piece of the sealing device according to the invention, of FIG. 2, wherein the section plane lies perpendicular to the section plane in FIG. 2.

FIG. 3b shows the counter-piece of FIG. 3a, seen from the longitudinal end which is opposite to the pressing piece.

FIG. 4 in a longitudinal section shows the pressing piece of the sealing device according to the invention of FIG. 2, wherein the section plane lies perpendicular to the section plane in FIG. 2.

FIG. 4b shows the pressing piece of FIG. 4a, seen from the longitudinal end lying opposite to the pressing piece.

FIG. 5 shows a further embodiment of a counter-piece for a sealing device according to the invention, in the longitudinal section and seen from a longitudinal end opposite to a pressing piece.

FIG. 5a shows a drawing of a sealing device according to the invention, in the dismantled condition, consisting of pressing piece, counter-piece and pins.

FIG. 5b shows a counter-piece and the pressing piece of FIG. 5a, in a partly assembled condition.

FIG. 5c shows a further drawing of the sealing device according to the invention of FIG. 5a, in the assembled condition.

FIG. 5d shows a drawing of a press coupling with an inserted pipe, sealed by the sealing device according to the invention, of the FIGS. 5a to 5c.

FIG. 5e shows a further embodiment of a counter-piece for a sealing device according to the invention, seen in side view and in the longitudinal direction from a longitudinal end opposite to the pressing piece.

FIG. 5f shows a further embodiment of a pressing piece for a sealing device according to the invention, seen in side view and in the longitudinal direction from a longitudinal end opposite to the counter-piece.

FIG. 6a in cross section, shows one possible embodiment of the connection between the two parts of a counter-piece for a sealing device according to the invention.

FIG. 6b in cross section, shows a further possible embodiment of the connection between two parts of a counter-piece for a sealing device according to the invention.

FIG. 7 shows a further possible embodiment of a counter-piece for a sealing device according to the invention, seen in the longitudinal direction from a longitudinal end opposite to the pressing piece.

FIG. 8 shows a further possible embodiment of a pressing piece for a sealing device according to the invention, seen in the longitudinal direction from a longitudinal end opposite to the counter-piece.

FIG. 9 in a longitudinal section, shows an untight press coupling with two inserted pipes, sealed by way of a further embodiment of a sealing device according to the invention.

FIG. 10 in a longitudinal section, shows a press coupling which is untight at two ends with two inserted pipes, sealed by a further embodiment of a sealing device according to the invention.

FIG. 11 in a longitudinal section, shows a press coupling which is untight at two ends, with two inserted pipes, sealed by a further embodiment of a sealing device according to the invention.

### DETAILED DESCRIPTION OF THE INVENTION

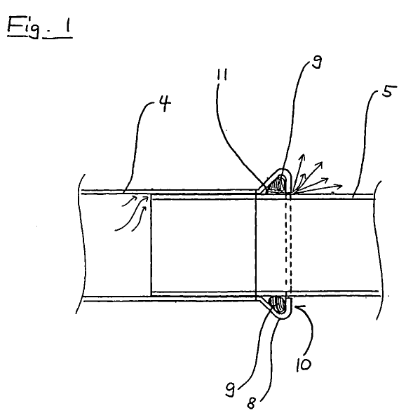

The problems of an untight press connection are evident in FIG. 1, which shows such a press connection in a longitudinal section. On creating such a connection, a pipe 5 is inserted into a press coupling 4, also called press fitting. This press fitting 4 which at its ends comprises a bead 8 with a sealing ring 9 applied therein, is subsequently irreversibly pressed with the pipe 5 by way of a tool suitable for this. Thereby, the sealing ring 9 is pressed flush onto the pipe 5 and the press connection is sealed. If however the sealing ring 9 is damaged, for example on assembly, a leakage 11 may occur. Fluid or gas under pressure may then flow through the leaky location out of the inside of the pipe 5 between the pipe and the coupling, and exit at the front side 10 of the coupling 4.

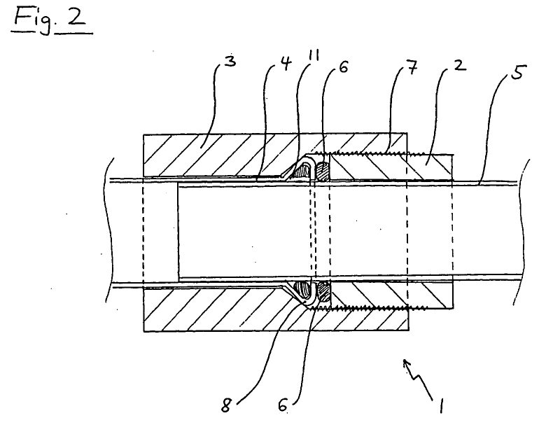

FIG. 2 is a longitudinal section showing one possible design of a sealing device 1 according to the invention, with a pressing piece 2 and a counter-piece 3. Before assembly of the sealing device 1 according to the invention, a seal 6 is attached on the front side of the coupling 4.

This seal cannot be a closed sealing ring since it indeed may not be pushed onto the pipe 5. Most simply, the seal 6 is created by wrapping sealing cord around the pipe 5, for example rubber cord or Teflon cord with e.g. 2 mm diameter.

Alternatively a modified sealing ring may be used, consisting of a cut through sealing ring. The sealing ring is cut in such a way that the cut surface of the two ends overlap. If such a sealing ring is mounted on the pipe and compressed during the assembly of the sealing device, the overlapping surfaces are pressed together, thereby closing the sealing ring.

In a further variant two or more cut sealing rings, with or without overlapping cut surfaces, can be mounted on the pipe in a way that the cut zones are evenly distributed along the circumference of the pipe.

The pressing piece 2 which encompasses the pipe 5, is screwed into the counter-piece 3 encompassing the coupling 4. On the inner side of the counter-piece 3, this stands on the bead 8 of the coupling 4. The previously attached seal 6 is pressed against the pipe 5 and the front side of the coupling 4 by way of rotating into the pressing piece 2. This pressure results in sealing the intermediate space between the bead 8 and the pipe 5. The press connection is thereby permanently sealed and repaired. The pressing piece 2 and the counter-piece 3 are advantageously manufactured of metal, in particular aluminum, steel, brass or chrome steel. However, a manufacture of suitable plastic is also possible.

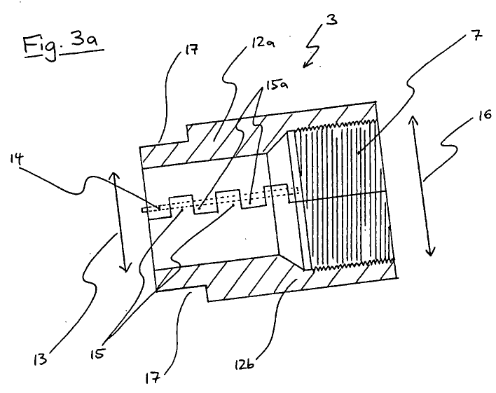

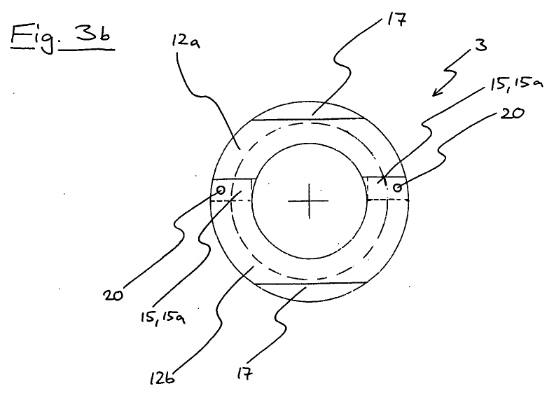

FIGS. 3a and 3b show the counter-piece 3 of FIG. 2 in a longitudinal section and seen from the longitudinal end opposite the pressing piece 2. The section plane of FIG. 3a thereby is perpendicular to the section plane in FIG. 2. The counter-piece is composed of a first part 12a and of a second part 12b. In the region of the smaller inner diameter 13, the two parts 12a, 12b comprise teeth 15, 15a which mutually engage and thus fix the position of the two parts to one another in the longitudinal direction. The teeth 15 have perpendicular walls which are shown in FIG. 3b by way of the dashed lines, in order for the second part 12b to be able to be pushed over a coupling. A bore 20 is incorporated on both sides continuously through the teeth 15, 15a through which in each case a pin 14 is inserted after the attachment to the pipe coupling, for the form-fit and force-fit connection of the two parts 12a, 12b transverse to the longitudinal axis. This pin, in an advantageous variant and at the outer lying end, is designed such that it may be removed again as the case may be. The diameter 16 of the inner thread 7 must always be larger than the maximal diameter of a coupling on the bead. Two recesses 17 are incorporated at the end of the counter-piece 3 which is opposite to the inner thread 7, on which for example joint pliers may engage.

In one possible variant, instead of two, one may also use four or six recesses 17. In the later case, the one end of the counter-piece 3 would have the shape of a hexagonal nut. It is also conceivable to design the counter-piece in a hexagonal manner over the entire length.

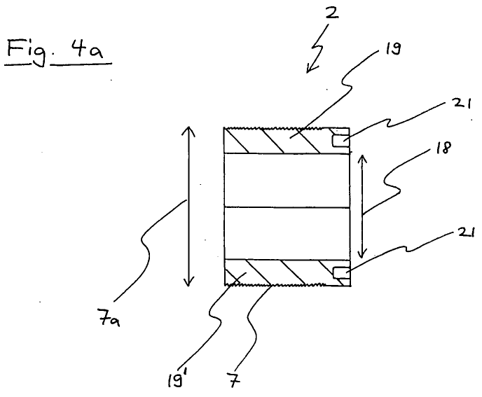

FIGS. 4a and 4b show the pressing piece 2 of FIG. 2 in a longitudinal section and seen from the longitudinal end opposite to the counter-piece 3. The section plane of FIG. 4a thereby is again perpendicular to the section plane in FIG. 2. The pressing piece 2 consists of two essentially identical parts 19, 19′. These are not connected to one another. However, these are automatically fixed in position to one another on screwing into the counter-piece 3. The diameter 7a of the outer thread corresponds to the inner thread of the counter-piece 3. The inner diameter 18 corresponds essentially to the outer diameter of the pipe. Both parts are provided with a bore 21, into which a key with corresponding cams may engage, in order to rotate the pressing piece 2 into the counter-piece 3.

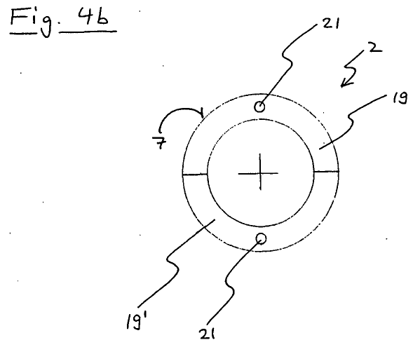

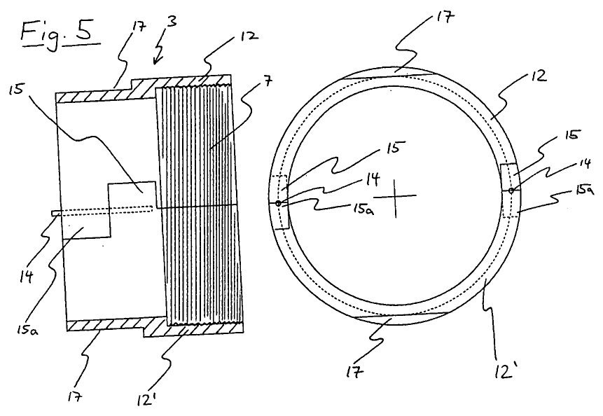

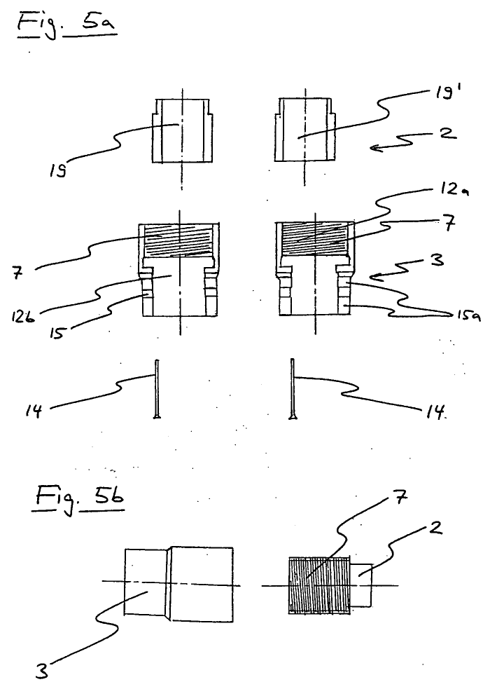

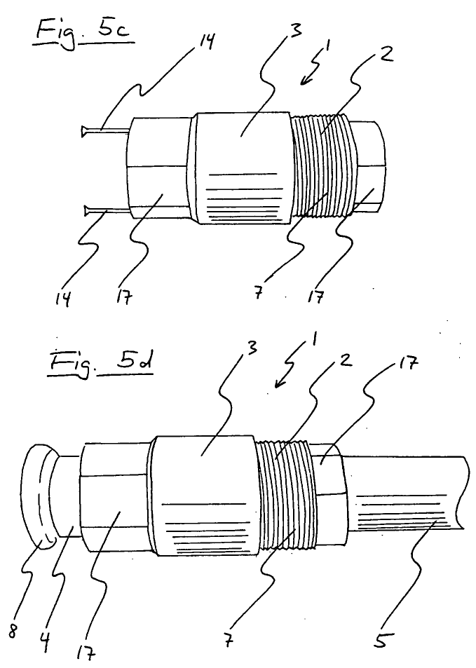

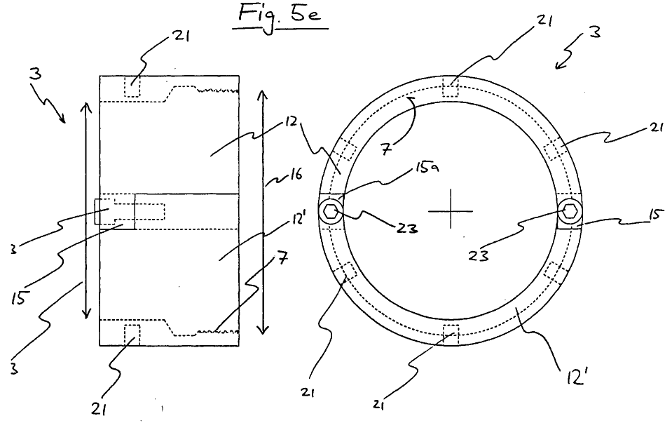

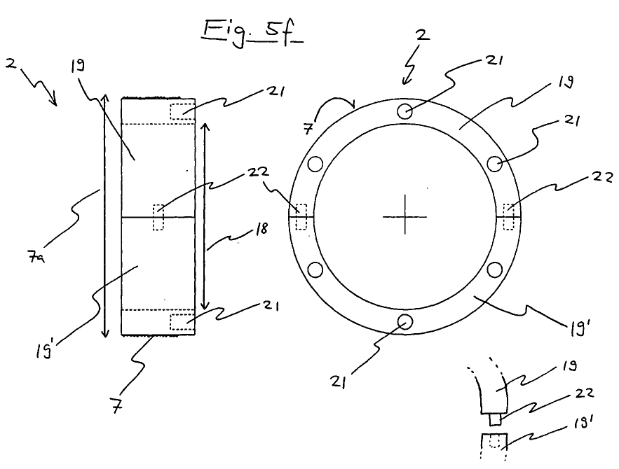

FIG. 5 shows a further embodiment for a counter-piece 3 for a sealing device according to the invention, in a longitudinal section and seen from the end opposite the pressing piece. In the depicted example, both parts 12, 12′ of the counter-piece 3 are essentially formed identically, with only one tooth 15, 15a on each side. The pins 14 are arranged continuously through the teeth 15, 15a lying symmetrically opposite one another. The teeth 15, 15a are again provided with straight walls. The recesses 17 protract over the large part of the threaded region. The thread-less region as well as the thread 7 are shorter in comparison to the diameter of the counter-piece, than in the example depicted FIGS. 2, 3a and 3b. The transition region between the threaded region and the thread-less region is formed perpendicular to the longitudinal axis, and is not conical.

One advantage of the counter-piece 3 in FIG. 5 is the fact that two identical parts 12, 12′ may be used, in the case that a fitting thread is selected. Furthermore, the shortened construction permits an assembly with restricted spatial conditions.

FIG. 5a shows a sealing device according to the invention in the dismantled condition, with a pressing piece 2 consisting of two parts 19, 19′, with an outer thread (not visible), with a counter-piece 3 consisting of two parts 12a, 12b, and two pins 14. The teeth 15, 15a are designed analogously to the counter-piece in FIGS. 3a, 3b.

FIGS. 5b and 5c show the same sealing device 1 in a partly assembled condition. The recesses 17 on the pressing piece 2 and on the counter-piece 3 are clearly visible in FIG. 5c.

FIG. 5d shows a press connection consisting of a press coupling 4 and pipe 5, sealed by way of the sealing device 1 according to the invention, of FIGS. 5a, 5b, 5c.

FIG. 5e shows a further embodiment of a counter-piece 3 for a sealing device according to the invention, seen in side view and in the longitudinal direction from a longitudinal end opposite to the pressing piece. As in FIG. 5 both parts 12, 12′ of the counter-piece 3 are essentially formed identically. The two parts 12, 12′ are connected by screws 23. In the depicted embodiment Allen/hex screws are used, but any other suitable screw may be used. The teeth 15, 15a have perpendicular walls. The transition zone between the threaded region with thread diameter 16 and the thread-less region with inner diameter 13 is conically shaped. Six radial bores 21 are arranged along the outer circumference of the counter-piece 3. Said bores can be used to hold the counter-piece 3 in position during assembly of the sealing device, or to apply a torque on the counter-piece 3, by inserting a suitable rod or simply a screw driver into one of the bores. The same solution is of course applicable for the pressing piece 2. The counter-piece 3 in FIG. 5e is well adapted for couplings and press fittings with larger diameters, for example 10 cm.

FIG. 5f shows a further embodiment of a pressing piece for a sealing device according to the invention, seen in side view and in the longitudinal direction from a longitudinal end opposite to the counter-piece. The two parts 19, 19′ are essentially identical. These, parallel to the separating plane of the parts, are undisplaceably fixed by cams 22 which engage into corresponding recesses of one part. The cams may all be attached distributed on one part or on both parts. The cams 22 may be arranged on one single part. However, it is of advantage to have a cam on each part, since then both parts 19, 19′ are exactly identical.

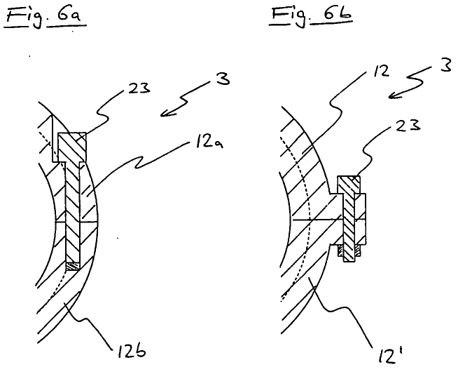

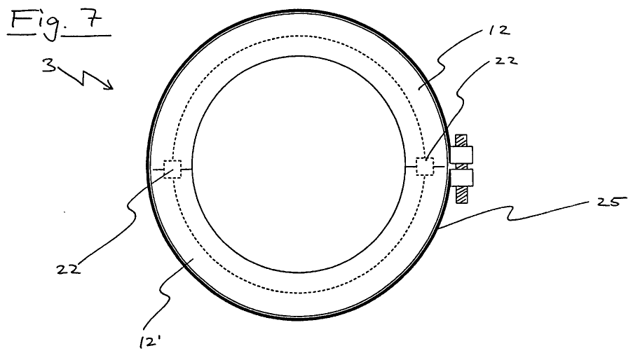

FIGS. 6a and 6b schematically in cross section, show two further possibilities for the form-fit and force-fit connection of two parts 12a, 12b of a counter-piece 3. In FIG. 6a, the two parts are connected by screws 23. Teeth are not necessary in such a design. In FIG. 6b, the screw 23 runs through two outer mountings which are integrally formed on identical parts 12, 12′. The screw is secured with a nut.

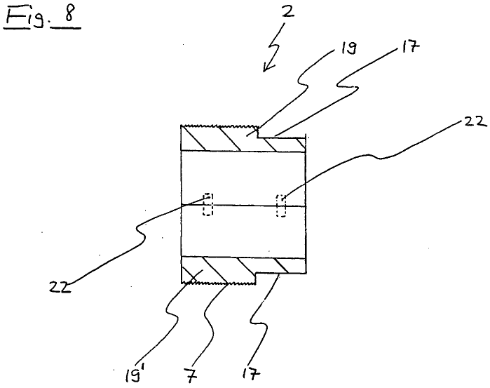

FIG. 7 shows a further embodiment of a counter-piece 3 for a sealing device according to the invention, seen from the end opposite the counter-piece. The two parts 12, 12′ are essentially identical. These, parallel to the separating plane of the parts, are undisplaceably fixed by cams 22 which engage into corresponding recesses of one part. The cams may all be attached distributed on one part or on both parts. One or more U-bolts or clamps are attached encompassing both parts, and hold together the parts perpendicular to the plane of separation. Even the use of the cable binders is possible. The embodiment has the advantage that it may be manufactured in a simple and therefore inexpensive method.

FIG. 8 in a longitudinal section shows a further embodiment for a pressing piece 2 of a sealing device according to the invention. The two parts are mutually protected against a displacement parallel to the separating plane between the two same parts 19, 19′ with cams 22.

Such a fixation in principle is not necessary, since the two parts are fixed anyway on insertion into the counter-piece. This variant however simplifies the handling on assembly.

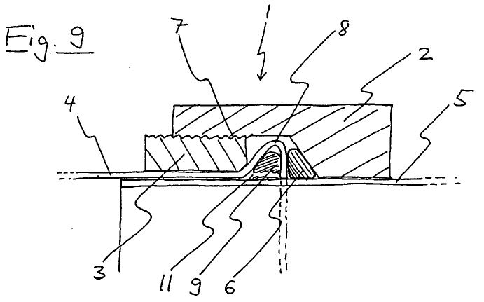

FIG. 9 in the longitudinal section schematically shows a further embodiment of a sealing device 1 according to the invention. In this example, the roles of the counter-piece 3 and the pressing piece 2 are reversed. The pressing piece 2 has an inner thread, and the counter-piece 3 has an outer thread. In this case, the at least two parts of the pressing piece 2 must be connected with a form- and force-fit. The depicted variant for the counter-piece and the pressing piece may in this context also be used for the depicted design of a sealing device according to the invention.

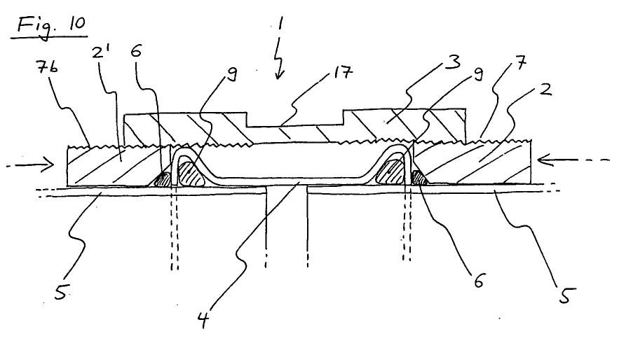

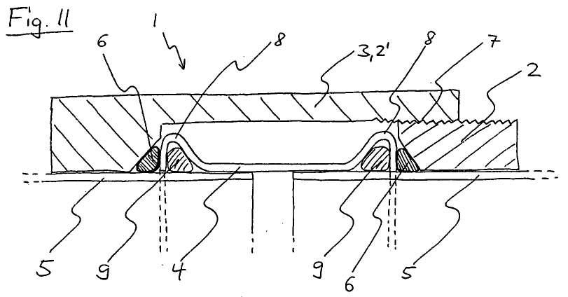

FIG. 10 in a longitudinal section shows a sealing device 1 according to the invention, for sealing a coupling or a press connection with two untight seals 9. The two pressing pieces 2, 2′ attached on the opposite ends of the coupling 4 are designed equally and differ only by way of the opposite running direction of the outer thread 7a and 7b. The counter-piece 3 at its opposite ends has a corresponding, counter-running inner thread.

FIG. 11 in a longitudinal section shows another embodiment of a sealing device 1 according to the invention, for sealing a joint or press connection with two untight seals 9. In this variant, the counter-piece 3 simultaneously serves as a second pressing piece 2′.

With restricted spatial conditions, for example with couplings on branches and arched pieces, it is advantageous to construct the sealing device that saves as much space as possible. In such a case, the pressing piece for example may be designed to be very short, for example with a length of only 5 mm. The outer thread then only has a few flights. The counter-piece may analogously be designed to be very short.

With sealing devices for larger couplings or press connections, it may be advantageous to design the pressing piece or the counter-piece of three or more parts In a further advantageous embodiment of the invention longitudinal ribs are arranged along the outer surface of the counter-piece and/or the pressing piece. This allows one to easily hold said pieces and to turn them manually. A user may then complete the assembly of the sealing device without a tool.

The present invention is not to be limited in scope by the specific embodiment described herein. Indeed, various modifications of the present invention, in addition to those described herein, will be apparent to those of skill in the art from the foregoing description and accompanying drawings.

### LIST OF REFERENCE NUMERALS

1 sealing device
2, 2′ pressing piece
3 counter-piece
4 coupling
5 pipe
6 seal
7 thread
7a thread diameter
7b counter thread
8 bead
9 sealing ring
10 front side
11 leak
12, 12′ part
12a first part
12b second part
13 inner diameter
14 pin
15, 15a tooth
16 thread diameter
17 recess
18 inner diameter
19, 19′ part
20, 21 bore
22 cams
23 screw
25 bolt/clamp

I claim:

1. A device for sealing untight couplings and press fitting connections, comprising
a pressing piece adapted for attaching around a pipe, the pressing piece comprising at least two parts;
a counter-piece adapted for attaching around a coupling connected to said pipe, the counter piece comprising at least two parts, the counter-piece further connectable to the pressing piece by one of form-fit and force-fit, and
a seal attached around the pipe, the seal pressable on the coupling and pipe by way of the pressing piece.

2. A device according to claim 1, wherein the at least two parts of the pressing piece and/or the at least two parts of the counter-piece in each case are connected to one another with a form-fit and/or force-fit.

3. A device according to one of the claims 1 or 2, wherein the pressing piece essentially has the form of a hollow cylinder, with an inner diameter which corresponds essentially to the outer diameter of the pipe.

4. A device according to claim 3, wherein the pressing piece on a longitudinal end comprises an outer thread and may be screwed into an inner thread of a counter-piece.

5. A device according to claim 3, wherein the pressing piece at a longitudinal end comprises an inner thread with a diameter which is larger than the inner diameter, wherein a counter-piece may be screwed into the inner thread.

6. A device according to claim 1 to 5, wherein the counter-piece has essentially the shape of a hollow cylinder with an inner diameter which corresponds essentially to the outer diameter of the coupling between two outer beads.

7. A device according to claim 6 with reference to claim 4, wherein the counter-piece at a longitudinal end comprises an inner thread with a diameter which is larger than the inner diameter, wherein a pressing piece may be screwed into the inner thread.

8. A device according to claim 6 with reference to claim 5, wherein the counter-piece at a longitudinal end comprises an outer thread and may be screwed into an inner thread of a pressing piece.

9. A device according to claim 1, wherein the counter-piece essentially has the shape of a hollow cylinder, with two inner threads arranged at opposite longitudinal ends, into which two pressing pieces may be screwed.

10. A kit for manufacturing a device for sealing untight couplings and press connections according to one of the claims 1 to 9.

11. A method for sealing untight couplings and press connections, wherein in any sequence, a pressing piece is attached on a pipe, a counter-piece is attached on a coupling, and a seal is attached on the mentioned pipe; and wherein subsequently, the pressing piece and the counter-piece are screwed, wherein thereby, the seal is pressed onto a front side of the coupling and onto the pipe.
